(19) United States
(12) Patent Application Publication
(10) Pub. No.: US 2026/0299612 A1
(43) Pub. Date: Oct. 1, 2026

(54) CONTROL METHOD FOR MOBILE BODY, CONTROL DEVICE FOR MOBILE BODY, MOBILE BODY, AND NON-TRANSITORY COMPUTER-READABLE STORAGE MEDIUM

(71) Applicant: HONDA MOTOR CO., LTD., Tokyo (JP)

(72) Inventors: Sango MATSUZAKI, Wako-shi (JP); Misa KOMURO, Wako-shi (JP)

(21) Appl. No.: 19/557,403

(22) Filed: Mar. 5, 2026

(30) Foreign Application Priority Data
Mar. 28, 2025 (JP) 2025-056641

(51) Int. Cl. G05D 1/686; G05D 105/22; G05D 105/28; G05D 105/30

(52) U.S. Cl. CPC G05D 1/686; G05D 2105/24; G05D 2105/28; G05D 2105/315

(57) ABSTRACT

A control method for a mobile body configured to lead a plurality of specific persons comprises identifying positions of a plurality of specific persons; identifying a position of a pedestrian; setting a real weight for each of the plurality of specific persons; calculating a guard position for each of the plurality of specific persons on a basis of the position of the specific person and the position of the pedestrian; calculating a lead position on a basis of the guard positions and the real weights of the specific persons, the lead position being a position used in controlling the mobile body; and controlling the mobile body on a basis of the lead position.

### CROSS-REFERENCE TO RELATED APPLICATION

This application claims priority to and the benefit of Japanese Patent Application No. 2025-056641, filed Mar. 28, 2025, the entire disclosure of which is incorporated herein by reference.

### BACKGROUND OF THE INVENTION

### Field of the Invention

The present invention relates to a control method for a mobile body, a control device for a mobile body, a mobile body, and a non-transitory computer-readable storage medium.

### Description of the Related Art

A mobile body, such as a robot, that autonomously moves together with a specific person, also referred to as a user, is known. For example, Japanese Patent Laid-Open No. 2008-149399 discloses a mobile body that moves together with a plurality of specific persons. This technique involves estimating desired speeds of the plurality of specific persons and controlling the mobile body at an average of the desired speeds or at a slower desired speed.

However, a problem with the above-mentioned technique is that the mobile body, which moves together with the plurality of specific persons on the basis of the desired speeds, cannot be controlled toward an appropriate position.

### SUMMARY OF THE INVENTION

The present invention has been made in view of the above problem and provides a technique capable of controlling a mobile body toward an appropriate position when the mobile body moves together with a plurality of specific persons.

According to an aspect of the present invention, there is provided a control method for a mobile body configured to lead a plurality of specific persons, the control method comprising: identifying positions of a plurality of specific persons; identifying a position of a pedestrian; setting a real weight for each of the plurality of specific persons; calculating a guard position for each of the plurality of specific persons on a basis of the position of the specific person and the position of the pedestrian; calculating a lead position on a basis of the guard positions and the real weights of the specific persons, the lead position being a position used in controlling the mobile body; and controlling the mobile body on a basis of the lead position.

### BRIEF DESCRIPTION OF THE DRAWINGS

FIG. 1 is a perspective view illustrating an overall configuration of a mobile body;

FIG. 2 is a schematic plan view illustrating a travel unit of the mobile body;

FIG. 3 is a block diagram of a control system of the mobile body;

FIG. 4 is a functional block diagram illustrating functions of a control unit;

FIG. 5 is a table illustrating a weight table;

FIG. 6 is a table illustrating specific features and real weight calculations for a plurality of users;

FIG. 7 is a plan view illustrating positions of the mobile body, the plurality of users, and a weighted guard centroid;

FIG. 8 is a plan view illustrating the positions of the mobile body and the plurality of guard-target users, and a position of the weighted guard centroid; and

FIG. 9 is a flowchart of drive control processing according to the embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### EMBODIMENT

In the following embodiment, a description is provided of an exemplary case where a micro-mobility vehicle is used as an example of a mobile body. The micro-mobility vehicle is, for example, a small-sized electric vehicle that is capable of carrying baggage and follows or leads a user (also referred to as a specific person). However, the present embodiment may also be applied to a micro-mobility vehicle that can carry not only baggage but also a person. Furthermore, the present embodiment is not limited to cases where the mobile body is an electric vehicle but is also applicable to mobile bodies other than electric vehicles. While the mobile body in the following description is exemplified as having a single driven wheel, the mobile body need not necessarily have a driven wheel, and the number of driven wheels is not limited to one but may be two or more.

A mobile body, such as the above-described micro-mobility vehicle, is useful if the mobile body can autonomously travel while accompanying one or more users. Furthermore, when accompanying a plurality of users, the mobile body is useful if the mobile body can lead (guide) the users from an appropriate position. The term “lead” may refer to traveling in front of a registered user without a preset destination. The term “guide” may refer to traveling in front of a user toward a destination preset by the user.

The mobile body according to the present embodiment alleviates user uneasiness by transmitting information to the user(s) through a human-machine interface (HMI) or the like while accompanying the user(s).

With reference to FIG. 1, a description is provided of how the mobile body 100 according to the present embodiment is configured. FIG. 1 is a perspective view illustrating an overall configuration of the mobile body. As illustrated in FIG. 1, the mobile body 100 according to the embodiment includes a lower housing 111, an upper housing 112, a front display unit 113, a plurality of detection units 114, a speech output unit 115, a light-emitting unit 116, two drive wheels 120, and the driven wheel 121. A side of the mobile body 100 on which the drive wheels 120 are provided is defined as the front side.

The lower housing 111 rotatably holds the drive wheels 120 and the driven wheel 121 and houses a travel unit that includes the drive wheels 120 and the driven wheel 121. The lower housing 111 has an upper portion with a loading space 118 capable of carrying baggage BG of a user. The lower housing 111 houses the light-emitting unit 116. A region of the lower housing 111 that houses the light-emitting unit 116 is made of a material that can transmit light.

The upper housing 112 extends upward from a rear portion of the lower housing 111. The upper housing 112 supports, at an upper end, the front display unit 113, the detection units 114, and the speech output unit 115.

The front display unit 113 notifies the user of information by means of images. The front display unit 113 may be a display device that displays images, such as a liquid crystal display or an organic electroluminescence (EL) display. The front display unit 113 is provided on a front side of the upper end of the upper housing 112. The front display unit 113 faces forward. The front display unit 113 displays images resembling human faces, characters, and the like to notify the user of information.

The plurality of detection units 114 detect targets around the mobile body 100, including people and objects. The detection units 114 may be digital cameras, each including an optical system, such as a lens, and an image sensor. The detection units 114 capture images of the surroundings and output resulting image data. The detection units 114 may each include, in place of or in addition to a camera, devices capable of detecting objects, such as a radar and a Light Detection and Ranging (LiDAR). The plurality of detection units 114 are provided, for example, at the front, rear, left, and right sides of the upper end of the upper housing 112. This arrangement enables the plurality of detection units 114 to capture images in all directions (i.e., 360°) around the mobile body 100 for generation of a resulting image. The locations of the detection units 114 and the number of detection units 114 are not particularly limited but may be changed as appropriate.

The speech output unit 115 notifies the user and other surrounding people of information through speech. The speech output unit 115 may be a speech output device, such as a speaker.

The light-emitting unit 116 notifies the user and other surrounding people of information through light. The light-emitting unit 116 includes, for example, one or more light-emitting elements, such as light-emitting diodes (LEDs). The light-emitting unit 116 is provided around the lower housing 111. The light-emitting unit 116 may emit light of multiple colors. The light-emitting unit 116 is capable of emitting light of different colors depending on a region or direction. In other words, the light-emitting unit 116 emits light of different colors, for example, in the front region 116F, the left region 116L, and the right region, respectively. Furthermore, the light-emitting unit 116 can switch each region between emitting light and turning off the light. Each region may be subdivided for finer light emission control.

The two drive wheels 120 are provided respectively on a left and a right side of a front lower portion of the lower housing 111. The drive wheels 120 rotate about their axles when driving force is transmitted from the travel unit.

The driven wheel 121 is provided at a middle of a rear lower portion of the lower housing 111. The driven wheel 121 is held to be rotatable about a vertical shaft extending in an up-down direction.

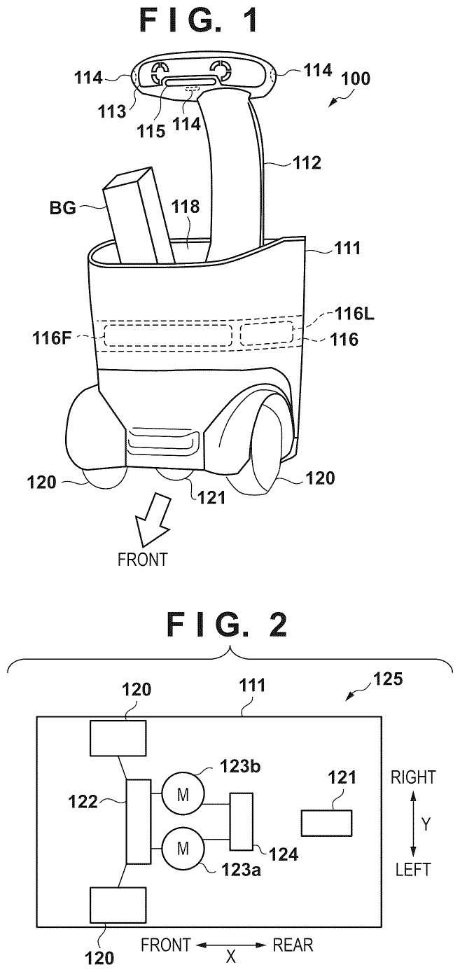

FIG. 2 is a schematic plan view illustrating the travel unit 125 of the mobile body 100. With reference to FIG. 2, a description is provided of the travel unit 125 of the mobile body 100.

The travel unit 125 is provided at a lower part of the lower housing 111. The travel unit 125 includes the two drive wheels 120, the driven wheel 121, a drive mechanism 122, a motor 123a, a motor 123b, and a battery 124.

When supplied with electric power from the battery 124, the motors 123a and 123b function as drive sources, supplying the driving force to the drive mechanism 122. The drive mechanism 122 transmits the driving force supplied from the motors 123a and 123b to the drive wheels 120. In this way, the drive mechanism 122 rotates the drive wheels 120 to move the mobile body 100 forward or backward. The drive mechanism 122 creates a rotational difference between the motors 123a and 123b, causing the mobile body 100 to travel either to the left or to the right. By varying the magnitude of the rotational difference, the drive mechanism 122 effects various types of turns of the mobile body 100, such as a pivot turn, a gentle turn, and a spin turn.

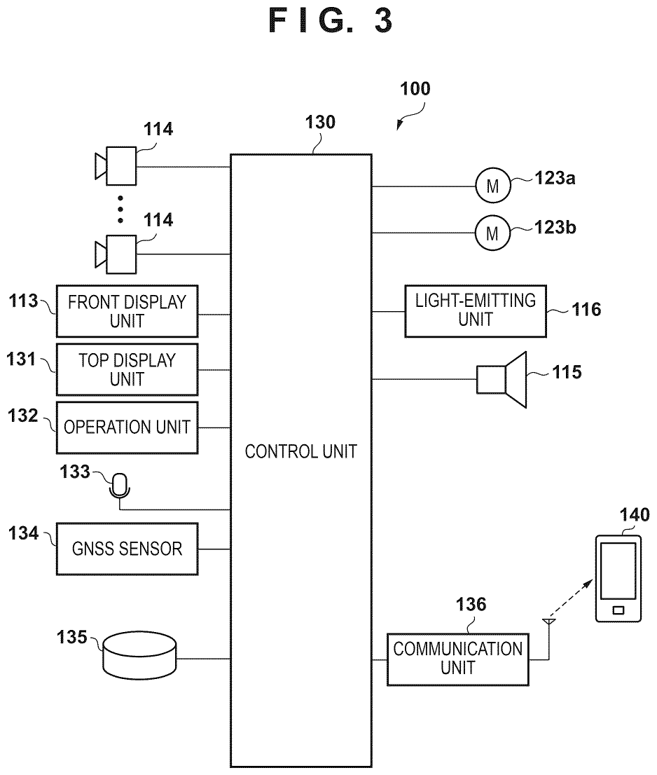

FIG. 3 is a block diagram of a control system of the mobile body 100. With reference to FIG. 3, a description is provided of the control system of the mobile body 100. As illustrated in FIG. 3, the mobile body 100 further includes a control unit 130, an operation unit 132, a top display unit 131, a voice input unit 133, a GNSS sensor 134, a storage device 135, and a communication unit 136.

The control unit 130 is an example of a control device and is also referred to as an electronic control unit (ECU). The control unit 130 may be a computer. The control unit 130 governs overall control of the mobile body 100. The control unit 130 includes at least one processor exemplified by a central processing unit (CPU), a memory device such as a semiconductor memory, and an interface with external devices, among others.

The processor may include, in place of or in addition to a CPU, a micro processing unit (MPU), a graphics processing unit (GPU), a neural processing unit (NPU), a quantum processing unit (QPU), or the like. The processor reads and executes a computer program stored in the memory device or the like to implement various functions of the control unit 130.

Some or all of the functions of the control unit 130 may be implemented by one or more circuits, such as an application-specific integrated circuit (ASIC) and a programmable logic device (PLD), including a field-programmable gate array (FPGA).

The memory device may be, for example, a random-access memory (RAM). The memory device stores the program to be executed by the processor and data to be used by the processor for processing, among others. A plurality of sets of processors, memory devices, and interfaces may be provided respectively for the functions of the mobile body 100, and the sets may be capable of communication with each other.

The control unit 130 obtains outputs, such as image information from the detection units 114, user input information obtained by the operation unit 132, voice information output by the voice input unit 133, and the like and performs processing corresponding to each piece of information. The control unit 130 controls behavior, including travel, of the mobile body 100 by controlling the motors 123a and 123b of the travel unit 125. The control unit 130 notifies the user or other surrounding people of information. For example, the control unit 130 notifies the user of information by controlling display of images on the front display unit 113 and the top display unit 131. The control unit 130 may notify the user of information through light emitted by the light-emitting unit 116. The control unit 130 may notify the user of information through speech output from the speech output unit 115. The control unit 130 may perform processing on the image information from the detection units 114, using a machine learning model (such as a deep neural network) for image recognition. Furthermore, the control unit 130 may perform processing on the voice information from the voice input unit 133, using a machine learning model (such as a deep neural network) for voice recognition.

The top display unit 131 may be a display device capable of displaying images. The top display unit 131 is provided on an upper face of the upper end of the upper housing 112. On the basis of image information obtained from the control unit 130, the top display unit 131 displays, for example, an image and characters regarding information that is to be notified to the user. The top display unit 131 displays, for example, an operation screen for receiving operations from the user.

The operation unit 132 may be an input device such as a touch panel or a keyboard. The operation unit 132 is provided, for example, on a display surface of the top display unit 131. The operation unit 132 receives input from the user and outputs the input to the control unit 130.

The voice input unit 133 may be a microphone or the like. The voice input unit 133 collects voice from the user of the mobile body 100 and the surroundings and outputs the collected voice to the control unit 130.

The GNSS sensor 134 receives GNSS signals from satellites to detect a current position of the mobile body 100. GNSS stands for Global Navigation Satellite System.

The storage device 135 includes a nonvolatile storage medium that stores various data. The storage device 135 may be, for example, a hard disk drive (HDD) or a solid-state drive (SSD). The storage device 135 may store programs to be executed by the processor, parameters necessary for program execution, and data to be processed by the processor, among others. The storage device 135 may store various parameters of the machine learning models for voice recognition and image recognition, which are executed by the control unit 130, such as learned parameters and hyperparameters of the deep neural networks.

The communication unit 136 communicates with external devices, such as a communication terminal 140 of the user, via wireless communication, such as Wi-Fi or fifth-generation mobile communication.

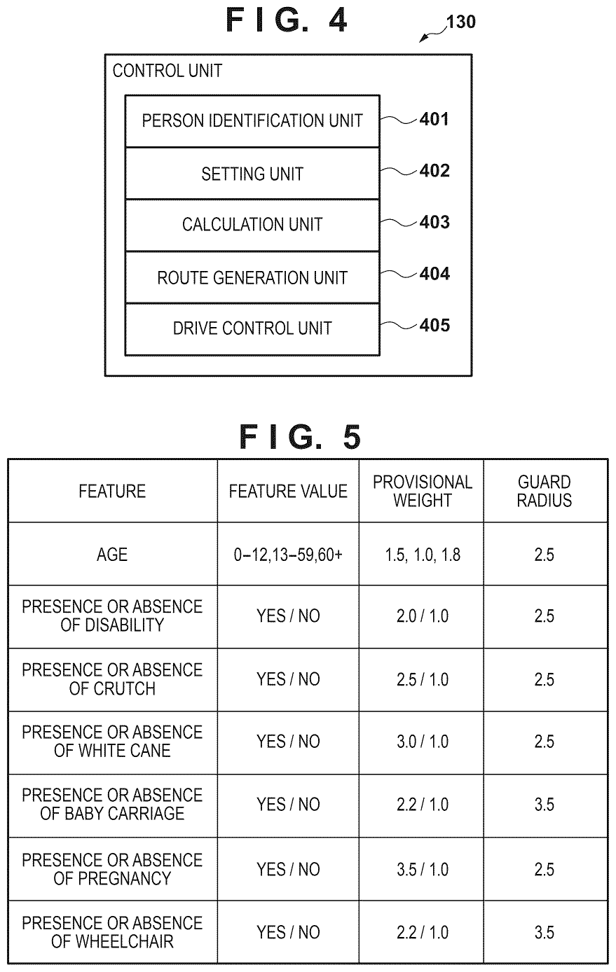

FIG. 4 is a functional block diagram illustrating the functions of the control unit 130. With reference to FIG. 4, a description is provided of the functions of the control unit 130.

The control unit 130 includes a person identification unit 401, a setting unit 402, a calculation unit 403, a route generation unit 404, and a drive control unit 405. For example, the control unit 130 may implement the person identification unit 401, the setting unit 402, the calculation unit 403, the route generation unit 404, and the drive control unit 405 by reading from the storage device 135 and executing a program for position change processing.

The person identification unit 401 identifies one or more users (also referred to as specific persons) and also identifies user positions to generate position information regarding those positions. The position referred to herein may be the user's current position. The user position may be a position defined relative to the mobile body 100 as an origin. For example, the user position may be identified in a rotational coordinate system that uses the mobile body 100 as the origin, uses distance from the mobile body 100, and defines a front face of the mobile body 100 as 0°. The user position may be identified in an orthogonal coordinate system with the mobile body 100 as the origin. The position information may include information regarding the user's speed, orientation of the user's face or body, and the like. The user is a person whom the mobile body 100 leads or follows. The person identification unit 401 may identify the user, for example, by performing face authentication on an image obtained from the detection units 114. The person identification unit 401 may identify the user by palm vein authentication, iris authentication, fingerprint authentication, or the like.

The person identification unit 401 identifies other pedestrians who are not to be followed or led. In other words, such pedestrians can be considered persons who are not users but are present around the mobile body 100. The person identification unit 401 identifies positions of these other pedestrians. The person identification unit 401 outputs the position information regarding the user position(s) and position information regarding the positions of the pedestrians to the setting unit 402, the calculation unit 403, the route generation unit 404, and the drive control unit 405.

The setting unit 402 sets a real weight for each of the one or more users. For example, the setting unit 402 sets the real weight based on the user's feature(s) (also referred to as attribute(s)). The setting unit 402 may identify the user's feature(s) on the basis of one or more images obtained from the detection units 114.

The setting unit 402 may determine the user's feature on the basis of the user's moving speed. For example, the setting unit 402 calculates the user's moving speed, such as walking speed, on the basis of a plurality of images. When a state in which the moving speed is equal to or less than (or less than) a preset threshold speed continues for a preset threshold time or longer (or longer than the threshold time), the setting unit 402 may determine that the user has a specific attribute.

The setting unit 402 may determine the user's feature(s) on the basis of the user's personal item(s). For example, on the basis of an image, the setting unit 402 detects an object accompanying the user or an object held by the user as the personal item. On the basis of the object, the setting unit 402 may determine whether or not the user has a specific attribute. For example, when an image shows the user with a crutch, a white cane, a baby carriage, a wheelchair, or the like, the setting unit 402 may identify the presence or absence of such a personal item as the user's feature.

The setting unit 402 may extract the user's height as the user's feature. For example, the setting unit 402 performs image-based detection of heights of a plurality of users. Among the plurality of users, the setting unit 402 may determine that the shortest user's attribute is a specific attribute.

The setting unit 402 may change the feature(s)-based real weight setting between offline and online modes.

For example, in the offline mode, the setting unit 402 determines, on the basis of, for instance, images, that the user's age, the presence or absence of the user's disability, the presence or absence of a crutch, the presence or absence of a white cane, the presence or absence of a baby carriage, the presence or absence of pregnancy, the presence or absence of a wheelchair, and the like are the features. The setting unit 402 may extract weights associated with these features from a preset weight table.

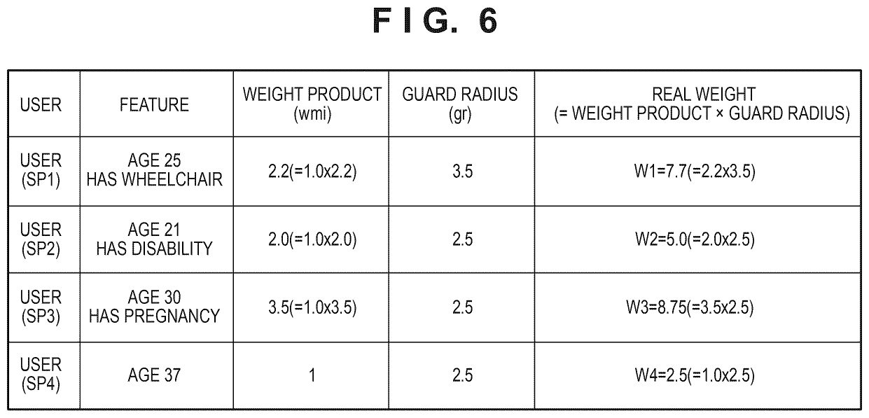

FIG. 5 is a table illustrating the weight table. FIG. 6 is a table illustrating specific features and real weight calculations for a plurality of users. The weight table associates the features with provisional weights and guard radii. The setting unit 402 calculates the real weight Wm (m=1, 2, . . . ) with reference to the weight table illustrated in FIG. 5.

The setting unit 402 extracts the features of the users SP. The setting unit 402 may extract the features of the users SP on the basis of images obtained from the detection units 114. Alternatively, the setting unit 402 may extract the features from, for example, a feature database that associates preregistered users SP with their features. The feature database is prestored, for example, in the storage device 135.

The setting unit 402 extracts all provisional weights corresponding to the features of each user SP. Among guard radii corresponding to the features of each user SP, the setting unit 402 extracts the greatest guard radius. The setting unit 402 calculates the real weight Wm by multiplying a product of all the extracted provisional weights by the guard radius.

Here, a description is provided of a case for a user SP1 having the features of age 25 and a wheelchair. The setting unit 402 extracts 1.0 as a provisional weight corresponding to the age 25 feature and 2.2 as a provisional weight corresponding to the wheelchair feature. The setting unit 402 also extracts 3.5, which is the greatest of the guard radii (2.5 and 3.5) associated with the features of the user SP1, as the guard radius. The setting unit 402 calculates, from the extracted provisional weights and guard radius, 7.7 (=1.0×2.2×3.5) as the real weight W1 of the user SP1. The setting unit 402 calculates the real weights Wm for all the users SP.

The setting unit 402 may identify the real weight of the user from a weight database that is prestored in the storage device 135 and associates users with their weights.

In the online mode, for example, the setting unit 402 detects, as the features, the level of the user's walking straightness, the magnitude of the user's walking curvature, the magnitude of the user's walking acceleration and deceleration, the magnitude of the user's speed of following the mobile body 100, and the user's average speed. The setting unit 402 may calculate the real weight by using a weight function preset for calculating the real weight from these features. The setting unit 402 may use predefined features derived from the detected features.

The setting unit 402 outputs the identified real weights of the users to the calculation unit 403.

The calculation unit 403 calculates various values necessary for generating a route for the mobile body 100. For example, the calculation unit 403 calculates a lead position to lead the mobile body 100. Specifically, the calculation unit 403 may calculate the lead position on the basis of the user position(s), the positions of the pedestrians, and the real weight(s) Wm, among others. The calculation of the lead position is described below.

First, the calculation unit 403 calculates a guard position GP for each user from the user and pedestrian positions. Specifically, the calculation unit 403 calculates the guard position GP based on the following Formula (1). Note that n represents the number of pedestrians.

$$\begin{matrix}[ Formula 1 ] & \\ GP = GuardDist \cdot \frac{{\sum }_{i = 1}^{n} {I}_{i} \cdot {e}_{ui}}{‖ {\sum }_{i = 1}^{n} {I}_{i} \cdot {e}_{ui} ‖} & ( 1 )\end{matrix}$$

GuardDist in Formula (1) is defined by the following Formula (2).

$$\begin{matrix}[ Formula 2 ] & \\ GuardDist = \{ \begin{matrix}2. & ( {min}_{i} {d}_{ui} > 2. ) \\ {min}_{i} {d}_{ui} & ( otherwise )\end{matrix} & ( 2 )\end{matrix}$$

In Formula (2), dᵤᵢ represents distance between the user SP and the pedestrian PS. minᵢdᵤᵢ represents a minimum value of dᵤᵢ.

Influence Iᵢ in Formula (1) refers to the influence Iᵢₜ at time t in Formula (3) below.

$$\begin{matrix}[ Formula 3 ] & \\ {I}_{i , t} = {e}^{- η \cdot {d}_{ui} \cdot ‖ {w}_{ui} ‖} {u}_{ui} & ( 3 )\end{matrix}$$

In Formula (3), η is a weight parameter and may be an empirically set value. η may be, for example, 1.0.

In Formula (3), a composite weight vector wᵤᵢ and a unit vector uᵤᵢ are defined by the following Formula (4).

$$\begin{matrix}[ Formula 4 ] & \\ {w}_{ui} = {λ}^{im} {υ}_{ui} + {e}_{ui} & ( 4 )\end{matrix}$$

$${u}_{ui} = \frac{{w}_{ui}}{‖ {w}_{ui} ‖}$$

In Formula (4), λ^{im} is a weight parameter and may be an empirically set value. For example, λ^{im} may be 0.5.

A unit relative position vector eᵤᵢ of the i-th pedestrian PSi with respect to the position of the user SP in Formulas (1) and (4) is defined by the following Formula (5).

$$\begin{matrix}[ Formula 5 ] & \\ {e}_{ui} = \frac{{p}_{i} - {p}_{u}}{‖ {p}_{i} - {p}_{u} ‖} & ( 5 )\end{matrix}$$

In Formula (5), positions Pᵤ and Pᵢ respectively represent the position of the u-th user SP and the position of the i-th pedestrian PSi.

Next, the calculation unit 403 calculates the lead position based on the respective guard positions GPm and the respective real weights Wm of the plurality of users SPm. The calculation unit 403 first calculates a weighted guard centroid Cg, which is a centroid of the guard positions GPm weighted by the real weights Wm, using Formula (6). As is evident from Formula (6), the weighted guard centroid Cg may be regarded as the centroid (also referred to as an arithmetic mean) of weighted guard positions, each of which is a product of the guard position GPm and the real weight Wm of the corresponding user SPm.

$$\begin{matrix}[ Formula 6 ] & \\ Cg = \frac{1}{M} {\sum }_{m = 1}^{M} Wm \cdot GPm & ( 6 )\end{matrix}$$

The calculation unit 403 next calculates an exclusion determination cost Vi used to determine whether or not to exclude the user from the guard targets, using the following Formula (7). Note that the position of the user excluded from the guard targets is not used in calculating the lead position.

$$\begin{matrix}[ Formula 7 ] & \\ Vi = α \cdot dgi + β \cdot dri & ( 7 )\end{matrix}$$

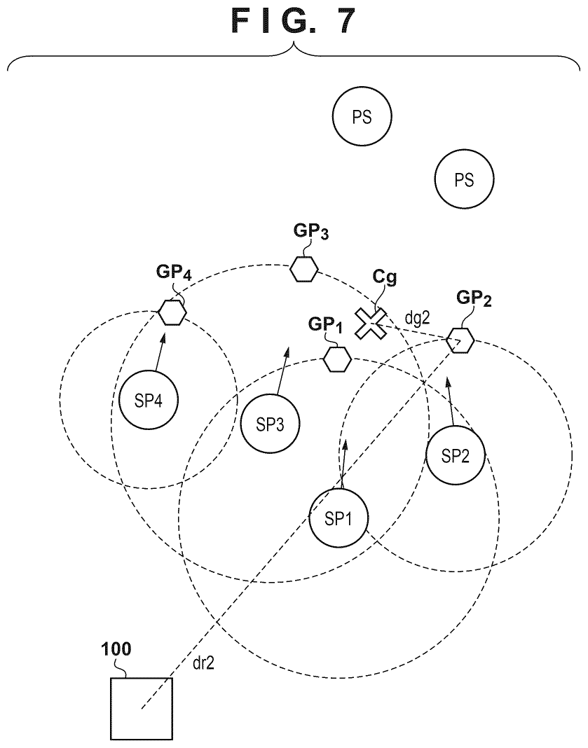

Distance d_{gi} is an example of a first distance and represents distance between the weighted guard centroid Cg and the guard position GP of each user SP. Distance dᵣᵢ is an example of a second distance and represents distance between the mobile body 100 and the guard position GP of each user SP. FIG. 7, which is described later, illustrates only the distance d_{g2} and the distance dᵣ₂ of the user SP2. A weight α and a weight β are preset weights. For example, the weight α may be a value that depends on an extent of an area that the mobile body 100 can guard, which in turn depends on size, the HMI, the mechanism, and other factors of the mobile body 100. When the mobile body 100 can guard a larger area from its current position, the weight α may be set smaller. The weight β may be a value that depends on motion performance of the mobile body 100. For example, when the motion performance of the mobile body 100 is low, the weight β is preferably set higher. In other words, when the motion performance of the mobile body 100 is low, increasing the weight β causes the mobile body 100 to exclude, from the guard targets, the user located far away.

The calculation unit 403 performs an exclusion determination that involves comparing the determination cost Vi with a threshold cost ThV and determining whether or not each user SP is to be guarded, that is, whether or not the position of each user SP is to be used in calculating the lead position. The calculation unit 403 excludes the user SP from the guard targets if the determination cost Vi is greater than or equal to the threshold cost ThV (or greater than the threshold cost ThV).

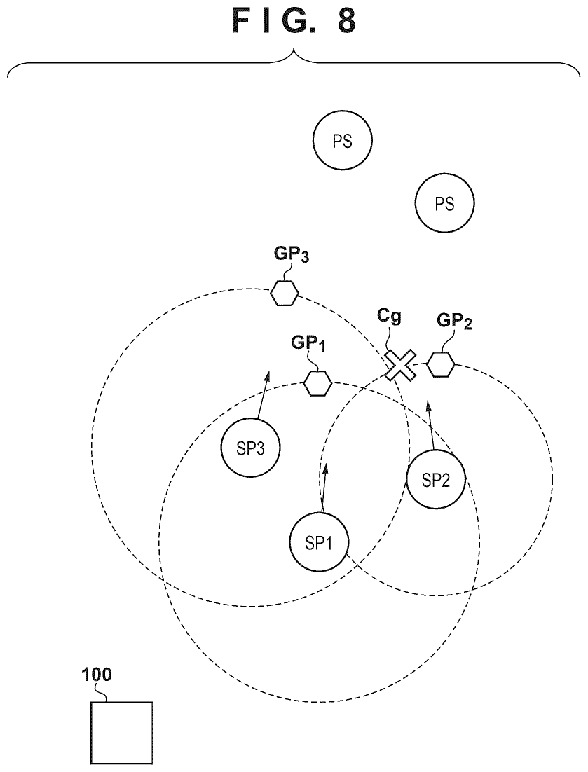

FIG. 7 is a plan view illustrating the positions of the mobile body and the plurality of users, and a position of the weighted guard centroid. FIG. 8 is a plan view illustrating the positions of the mobile body and the plurality of guard-target users, and a position of the weighted guard centroid. Each circle indicated by a dotted line in FIGS. 7 and 8 is a circle having, as its radius, the real weight, which is the product of the provisional weight(s) and the guard radius.

For example, in the case illustrated in FIG. 7, the calculation unit 403 calculates the guard positions on the basis of the positions of the four users and other information and calculates the weighted guard centroid and the position of the mobile body 100. The calculation unit 403 compares the determination cost Vi, which has been calculated from the guard position, the weighted guard centroid, and the position of the mobile body 100, with the threshold cost ThV to determine the user SP to be excluded. In this case, the calculation unit 403 excludes the user SP4 from the guard targets.

As a result, as illustrated in FIG. 8, the guard-target users become three in number. The calculation unit 403 further determines the user SP to be excluded on the basis of the positions of the three users SP remaining after the exclusion target has been excluded. In the case illustrated in FIG. 8, the calculation unit 403 determines that no user SP is to be excluded.

In this manner, the calculation unit 403 repeats its exclusion determination process for the remaining users SP, after excluding the guard target(s) determined to be excluded. The calculation unit 403 repeats the exclusion determination process, which involves comparing the determination cost Vi with the threshold cost ThV, until there are no more users SP to be excluded from the guard targets. When the calculation unit 403 compares the determination costs Vi with the threshold cost ThV and determines that there are no more users SP to be excluded from the guard targets, the calculation unit 403 sets the weighted guard centroid Cg at that time as the lead position for the mobile body 100 and outputs the lead position to the route generation unit 404.

The route generation unit 404 generates a travel route from the current position of the mobile body 100 to the lead position calculated by the calculation unit 403. The route generation unit 404 outputs the generated travel route to the drive control unit 405.

The drive control unit 405 controls the motors 123a and 123b on the basis of the travel route, thereby causing the mobile body 100 to travel to the lead position.

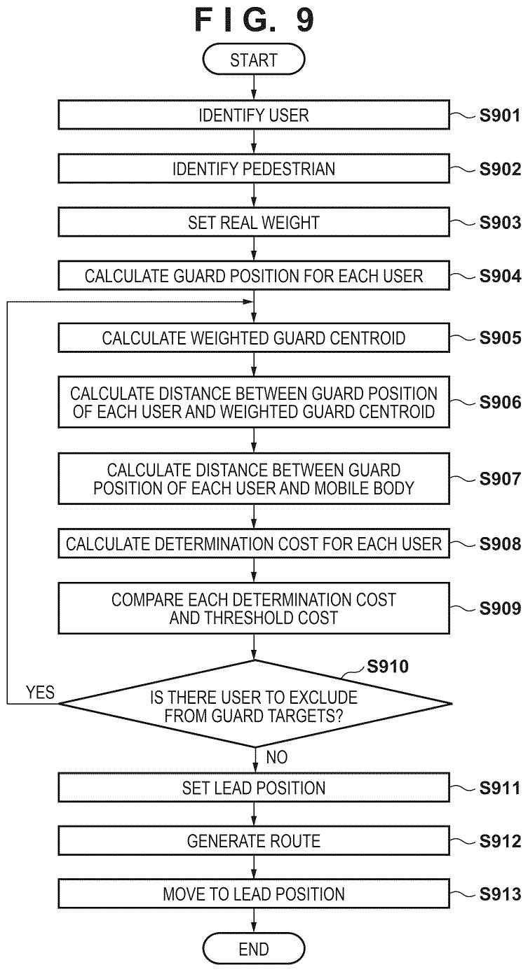

FIG. 9 is a flowchart of drive control processing according to the embodiment. For example, the control unit 130 performs the drive control processing by reading and executing a program for the drive control processing stored in the storage device 135.

In the drive control processing, at S901, the person identification unit 401 identifies one or more users to be led or followed. The person identification unit 401 may identify the user and a position of the user on the basis of images obtained from the detection units 114. The person identification unit 401 may identify a plurality of users. Thereafter, the person identification unit 401 proceeds to step S902.

At S902, the person identification unit 401 identifies positions of pedestrians around the user(s). The person identification unit 401 may identify the positions of the pedestrians on the basis of images obtained from the detection units 114. Thereafter, the person identification unit 401 outputs information including the user and pedestrian positions to the setting unit 402, the calculation unit 403, and the route generation unit 404. The processing proceeds to step S903.

At S903, the setting unit 402 sets a real weight for each user. For example, the setting unit 402 extracts features of the users on the basis of images obtained from the detection units 114. The setting unit 402 may extract a provisional weight and a guard radius on the basis of each feature and set the real weight for each user. Thereafter, the setting unit 402 outputs the real weights to the calculation unit 403. The processing proceeds to step S904.

At S904, the calculation unit 403 calculates a guard position for each user. For example, the calculation unit 403 may calculate the guard position on the basis of the user position and the pedestrian positions. Thereafter, the calculation unit 403 proceeds to step S905.

At S905, the calculation unit 403 calculates a weighted guard centroid. The calculation unit 403 may calculate the weighted guard centroid on the basis of each user's guard position and real weight. Thereafter, the calculation unit 403 proceeds to step S906.

At S906, the calculation unit 403 calculates the distance d_{gi} between each user's guard position and the weighted guard centroid and proceeds to step S907.

At S907, the calculation unit 403 calculates the distance dᵣᵢ between each user's guard position and the mobile body 100 and proceeds to step S908.

At S908, the calculation unit 403 calculates the determination cost Vi for each user. The calculation unit 403 may calculate the determination cost Vi on the basis of the weight α, the weight β, the distance d_{gi}, and the distance dᵣᵢ.

Thereafter, the calculation unit 403 proceeds to step S909.

At S909, the calculation unit 403 compares the determination cost Vi of each user with the threshold cost ThV and proceeds to step S910.

At S910, the calculation unit 403 performs an exclusion determination based on results of the comparison between the determination cost Vi and the threshold cost ThV to determine whether or not there are any users to be excluded from the guard targets. The calculation unit 403 may determine that the user whose determination cost Vi is greater than or equal to the threshold cost ThV (or greater than the threshold cost ThV) is to be excluded from the guard targets. If the calculation unit 403 determines that the user or users to be excluded from the guard targets exist (S910: Yes), the calculation unit 403 returns to step S905. Thereafter, the calculation unit 403 repeats step S905 for the remaining users, after excluding the user(s) no longer considered guard targets. On the other hand, if the calculation unit 403 determines that there exist no users to be excluded from the guard targets (S910: No), the calculation unit 403 proceeds to step S911.

At S911, the calculation unit 403 sets a lead position. The calculation unit 403 may set the last-calculated weighted guard centroid for which no exclusion targets exist as the lead position. The calculation unit 403 outputs the set lead position to the route generation unit 404, and the processing proceeds to step S912.

At S912, the route generation unit 404 generates a travel route from the current position of the mobile body 100 to the lead position. The route generation unit 404 outputs the travel route to the drive control unit 405, and the processing proceeds to step S913.

At S913, the drive control unit 405 controls the motors 123a and 123b on the basis of the travel route, thereby causing the mobile body 100 to move to the lead position.

With this, the control unit 130 ends the drive control processing.

As described above, the embodiment involves calculating the lead position, which is used in controlling the mobile body 100, on the basis of the positions of the users to be led, the pedestrian positions, and the real weights. As a result, even when the mobile body 100 moves together with the plurality of users, the embodiment enables the mobile body 100 to be controlled toward the appropriate lead position in accordance with the user positions.

In the embodiment, since the lead position is calculated on the basis of the weighted guard centroid, which is the centroid of the products of the users' guard positions and real weights, calculation of a more appropriate lead position is possible.

In the embodiment, on the basis of the distance d_{gi} between the weighted guard centroid and the guard position of the user and the distance dᵣᵢ between the mobile body 100 and the guard position of the user, a determination is made as to whether the user is to be used or excluded in calculating the lead position. As a result, the embodiment allows for appropriate selection of users to be guarded.

In the embodiment, the determination is made as to whether or not the user is to be excluded on the basis of a product of the weight α, which depends on the extent of the area that can be guarded by the mobile body 100, and the distance d_{gi} and a product of the weight β, which depends on the motion performance of the mobile body 100, and the distance dᵣᵢ. As a result, the embodiment allows for more appropriate selection of users to be guarded, taking the mobile body 100 into account.

In the embodiment, since the lead position is calculated on the basis of the positions of the users remaining after the exclusion of the user(s) to be excluded, calculation of a more appropriate lead position based on positions of users to be guarded is possible.

In the embodiment, the exclusion determination is repeated until the users to be excluded no longer exist. As a result, the embodiment allows for calculation of a more appropriate lead position based on positions of users to be guarded.

In the embodiment, the user's feature is identified in setting the real weight. As a result, the embodiment allows for setting an appropriate real weight in accordance with the user's state.

In the embodiment, the real weight is set on the basis of the product of the provisional weight and the guard radius that are associated with the user's feature. As a result, the embodiment allows for setting a more appropriate real weight.

In the embodiment, when the plurality of provisional weights are extracted on the basis of the user's features, the real weight is set on the basis of the product of the plurality of provisional weights. As a result, the embodiment allows for setting a more appropriate real weight for a user having a plurality of different features.

In the embodiment, the real weight is set on the basis of features including at least one of a personal item, age, a speed, or a physical characteristic of the user. As a result, the embodiment allows for setting a more appropriate real weight.

### MODIFICATIONS OF EMBODIMENT

The above-described embodiment may be modified as appropriate. For example, any of the steps in the flowchart of the embodiment may be omitted. Specifically, with steps S906 to S910 omitted, a lead position may be calculated on the basis of the positions of all of the users without exclusion of any user.

The method for calculating the real weight is not limited to the above-described calculation method. For example, when a plurality of provisional weights are extracted from features of a user, the setting unit 402 may calculate a real weight based on a largest or smallest one of the provisional weights.

In the above-described embodiment, the exemplary case where the control device is the control unit 130 of the mobile body 100 has been described. However, the control device may be included, for example, in an information processing server located outside the mobile body 100. In that case, the control device may perform part or all of the processing performed by the control unit 130 described above while communicating with the mobile body 100. In other words, the present embodiment is also applicable to cases where the mobile body 100 is controlled remotely from a device separate from the mobile body 100.

### SUMMARY OF EMBODIMENT

The foregoing embodiment discloses at least the following control method and control device.

1. A control method for a mobile body configured to lead a plurality of specific persons (SP), the control method comprising:
identifying positions of a plurality of specific persons (SP);
identifying a position of a pedestrian (PS);
setting a real weight for each of the plurality of specific persons (SP);
calculating a guard position (GP) for each of the plurality of specific persons (SP) on a basis of the position of the specific person (SP) and the position of the pedestrian (PS);
calculating a lead position on a basis of the guard positions (GP) and the real weights of the specific persons (SP), the lead position being a position used in controlling the mobile body (100); and
controlling the mobile body (100) on a basis of the lead position.

According to the embodiment, even when the mobile body moves together with the plurality of specific persons, the mobile body can be controlled toward the appropriate lead position in accordance with the positions of the specific persons.

2. In the embodiment,
the lead position is calculated on a basis of a weighted guard centroid (Cg) that is a centroid of weighted guard positions (GP) of the plurality of specific persons (SP), each of the weighted guard positions (GP) being a product of the guard position (GP) and the real weight.

According to the embodiment, since the lead position is calculated on the basis of the weighted guard centroid, which is the centroid of the products of the specific persons' guard positions and real weights, calculation of a more appropriate lead position is possible.

3. In the embodiment,
on a basis of a first distance (dgi) between the weighted guard centroid (Cg) and the guard position (GP) of a specific person (SP) and a second distance (dri) between the mobile body (100) and the guard position (GP) of the specific person (SP), an exclusion determination is made as to whether or not the specific person (SP) is to be used in calculating the lead position.

According to the embodiment, appropriate selection of specific persons to be guarded is possible.

4. In the embodiment, the exclusion determination is made on a basis of a product of a first weight and the first distance (dgi) and a product of a second weight and the second distance (dri), the first weight (α) depending on an extent of an area that can be guarded by the mobile body (100), the second weight (β) depending on motion performance of the mobile body (100).

According to the embodiment, in consideration of, for example, the performance of the mobile body, more appropriate selection of specific persons to be guarded is possible.

5. In the embodiment,
the lead position is set on a basis of the positions of the specific persons (SP) remaining after exclusion of the specific persons (SP) determined not to be used in calculating the lead position.

According to the embodiment, calculation of a more appropriate lead position based on positions of specific persons to be guarded is possible.

6. In the embodiment,
the exclusion determination is repeated until the specific persons (SP) to be excluded no longer exist.

According to the embodiment, calculation of a more appropriate lead position based on positions of specific persons to be guarded is possible.

7. In the embodiment,
the real weight is set on a basis of a feature of the specific person (SP).

According to the embodiment, an appropriate real weight can be set in accordance with the specific person's state.

8. In the embodiment,
the real weight is set on a basis of at least one provisional weight and a guard radius that are associated with the feature of the specific person (SP).

According to the embodiment, a more appropriate real weight can be set.

9. In the embodiment,
when a plurality of provisional weights (α) are extracted on a basis of a plurality of features of the specific person (SP), the real weight is set on a basis of a product of the plurality of provisional weights (α).

According to the embodiment, a more appropriate real weight can be set for a specific person having a plurality of different features.

10. In the embodiment,
a plurality of features include at least one of a personal item, age, a speed, or a physical characteristic of the specific person (SP).

According to the embodiment, a more appropriate real weight can be set.

The invention is not limited to the foregoing embodiments, and various variations/changes are possible within the spirit of the invention.

What is claimed is:

1. A control method for a mobile body configured to lead a plurality of specific persons, the control method comprising:
identifying positions of a plurality of specific persons;
identifying a position of a pedestrian;
setting a real weight for each of the plurality of specific persons;
calculating a guard position for each of the plurality of specific persons on a basis of the position of the specific person and the position of the pedestrian;
calculating a lead position on a basis of the guard positions and the real weights of the specific persons, the lead position being a position used in controlling the mobile body; and
controlling the mobile body on a basis of the lead position.

2. The control method for a mobile body according to claim 1, wherein
the lead position is calculated on a basis of a weighted guard centroid that is a centroid of weighted guard positions of the plurality of specific persons, each of the weighted guard positions being a product of the guard position and the real weight.

3. The control method for a mobile body according to claim 2, wherein
on a basis of a first distance between the weighted guard centroid and the guard position of a specific person and a second distance between the mobile body and the guard position of the specific person, an exclusion determination is made as to whether or not the specific person is to be used in calculating the lead position.

4. The control method for a mobile body according to claim 3, wherein
the exclusion determination is made on a basis of a product of a first weight and the first distance and a product of a second weight and the second distance, the first weight depending on an extent of an area that can be guarded by the mobile body, the second weight depending on motion performance of the mobile body.

5. The control method for a mobile body according to claim 3, wherein
the lead position is set on a basis of the positions of the specific persons remaining after exclusion of the specific persons determined not to be used in calculating the lead position.

6. The control method for a mobile body according to claim 3, wherein
the exclusion determination is repeated until the specific persons to be excluded no longer exist.

7. The control method for a mobile body according to claim 1, wherein
the real weight is set on a basis of a feature of the specific person.

8. The control method for a mobile body according to claim 7, wherein
the real weight is set on a basis of at least one provisional weight and a guard radius that are associated with the feature of the specific person.

9. The control method for a mobile body according to claim 8, wherein
when a plurality of provisional weights are extracted on a basis of a plurality of features of the specific person, the real weight is set on a basis of a product of the plurality of provisional weights.

10. The control method for a mobile body according to claim 7, wherein
a plurality of features include at least one of a personal item, age, a speed, or a physical characteristic of the specific person.

11. A control device for a mobile body configured to lead a plurality of specific persons, the control device comprising:
a person identification unit configured to identify positions of a plurality of specific persons and a position of a pedestrian;
a setting unit configured to set a real weight for each of the plurality of specific persons;
a calculation unit configured to calculate a guard position for each of the plurality of specific persons on a basis of the position of the specific person and the position of the pedestrian and calculate a lead position on a basis of the guard positions and the real weights of the specific persons, the lead position being a position used in controlling the mobile body; and
a drive control unit configured to control the mobile body on a basis of the lead position.

12. A mobile body comprising:
the control device for a mobile body according to claim 11; and
a travel unit configured to move the mobile body.

13. A non-transitory computer-readable storage medium storing a program for causing a computer to perform each step in the control method for the mobile body of claim 1.
